(19) United States
(12) Patent Application Publication
(10) Pub. No.: US 2007/0178226 A1
(43) Pub. Date: Aug. 2, 2007

(54) Printed circuit board

(75) Inventor: Marcus Baertele, Ulm (DE)

Correspondence Address: GREENBLUM & BERNSTEIN, P.L.C., 1950 ROLAND CLARKE PLACE, RESTON, VA, 20191, US

(73) Assignee: EADS DEUTSCHLAND GMBH, Ottobrunn (DE)

(21) Appl. No.: 10/598,391

(22) PCT Filed: Jan. 26, 2005
(86) PCT No.: PCT/DE05/00104

§ 371 Date: Aug. 25, 2006

(30) Foreign Application Priority Data
Feb. 28, 2004 (DE) 10 2004 009 825.5

(51) Int. Cl. B05D 5/12

(52) U.S. Cl. 427/78

(57) ABSTRACT

An arrangement for increasing the packing density on a printed circuit with surface mounted electrical components. The printed circuit is formed by two films which are pressed against one another with a dielectric arranged between them. At least one of the mutually opposite faces of the films are fitted with surface mounted electrical components. The via holes are provided in the printed circuit in order to connect the two films, with each via hole being a direct connection between the mutually opposite faces of the films.

The invention relates to an arrangement for increasing the packing density of surface mounted electrical components on a printed circuit.

It is known for surface mounted electrical components (SMD—surface mounted devices) to be used to reduce the size of circuit fittings. These surface mounted devices are in this case fitted an one or both faces of a printed circuit. One disadvantage of the arrangement is that the distances between the surface mounted devices are too large because the frequency values to be processed are rising. This is associated with considerable additional circuit complexity in order to compensate for excessive signal delay times. A further disadvantage of this arrangement is that the packing density on the printed circuit cannot be increased indefinitely. The population of a printed circuit is thus subject to natural limits in the form of the geometric dimensions of a surface mounted device.

A printed circuit of this generic type is known from EP 1. 139 705 A1. The printed circuit comprises a core substrate with three electrically conductive substrates which are pressed against one another and surround the electrical components, as well as contact-making layers, with each contact-making layer in turn comprising a plurality of layers of a dielectric.

One object of the invention is thus to specify an arrangement by means of which the packing density of surface mounted devices on a printed circuit can be increased while taking into account a simple design and short signal paths.

This object is achieved by the arrangement as claimed in patent claim 1. Advantageous embodiments of the invention are the subject matter of dependent claims.

The arrangement to increase the packing density of surface mounted electrical components on a printed circuit comprises, according to the invention, a printed circuit which is formed by two films which are pressed against one another and have a dielectric arranged between them., with at least one of the mutually opposite faces of the films being fitted with surface mounted electrical components, as well as via holes, which are provided in the printed circuit, for connection of the two films, with each via hole being a direct connection between the mutually opposite faces of the films.

This arrangement allows a considerably higher packing density on a printed circuit, since surface mounted devices are arranged in the interior of the printed circuit. Furthermore., the arrangement according to the invention makes it possible to reduce the signal path lengths between the surface mounted devices. The via holes are holes and may in particular be microvias, and may be produced by means of drilling, electroplating or etching processes.

In a first advantageous embodiment of the invention, further surface mounted devices are arranged on the faces of the films which are not mutually opposite. This allows the packing density of surface mounted devices on a printed circuit to be increased further. The films that are used advantageously contain copper. However, it is, of course, also possible to use other materials that have high electrical conductivity.

In a second advantageous embodiment, the printed circuit has first contacts which are formed on at least one face of the printed circuit. These contacts make it possible, for example, to produce electrical connections with other printed circuits. These electrical connections may, for example, be bonding connections or soldered joints to other printed circuits or electrical components, for example microchips.

In a further advantageous embodiment of the invention, a further layer of a dielectric as well as a further film are applied to at least one face of the printed circuit.

A further advantageous embodiment is a stack of printed circuits according to the invention.

The invention will be explained in more detail in the following text with reference to drawings, in which:

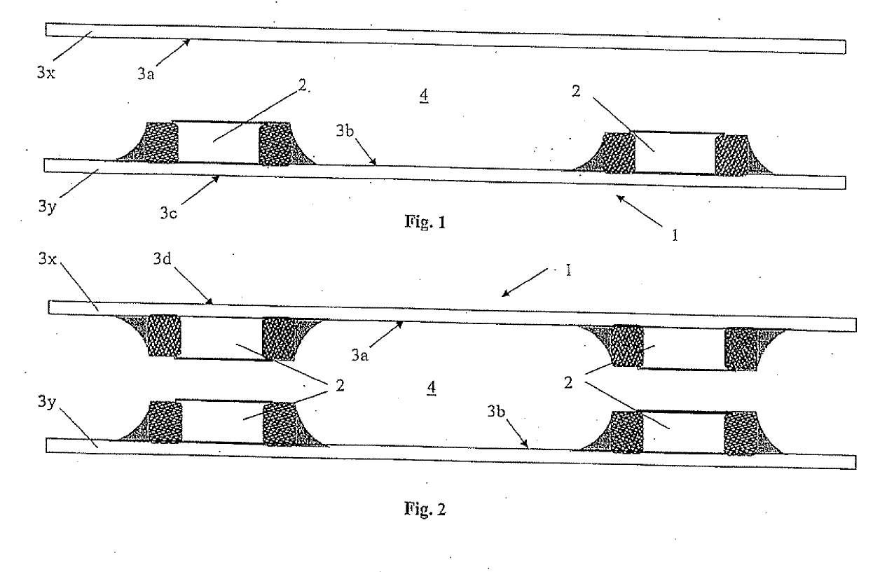

FIG. 1 shows a first exemplary embodiment of a printed circuit according to the invention with surface mounted devices which are fitted to one face of a film,

FIG. 2 shows a second exemplary embodiment of a printed circuit according to the invention with surface mounted devices which are fitted to mutually facing faces of the two films,

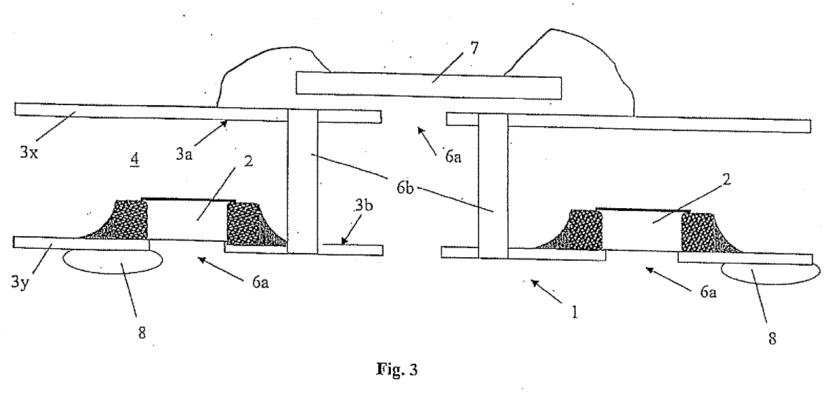

FIG. 3 shows the second exemplary embodiment of a printed circuit according to the invention with contacts, and

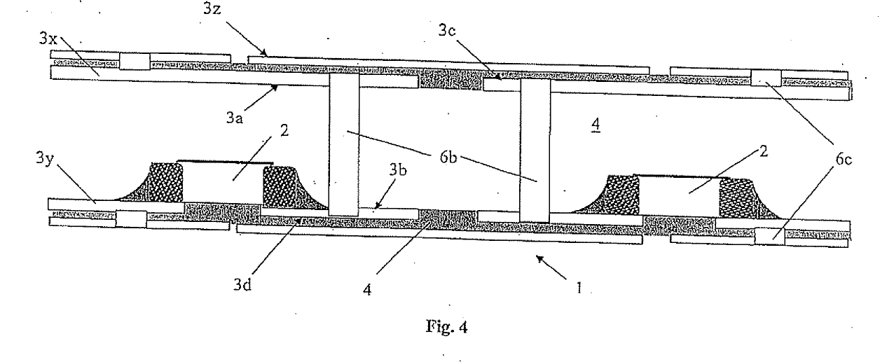

FIG. 4 shows a further exemplary embodiment of a printed circuit according to the invention with further layers composed of dielectric and film.

FIG. 1 shows a section at right angles through a printed circuit for a first embodiment of a printed circuit 1 according to the invention with surface mounted devices 2 which are fitted to the inner face 3a of a film 3x, 3y. The surface mounted devices 2 are arranged between two films 3x, 3y and are embedded in a dielectric 4. The connection between the surface mounted device 2 and the film 3x, 3y is a soldered joint 5. FIG. 2 shows a section at right angles through a second embodiment of a printed circuit according to the invention with surface mounted devices 2 which are fitted to the inner faces 3a, 3b of both films.

FIG. 3 shows a section at right angles through a printed circuit 1 according to the invention with contacts 6a, 6b. In this case, first contacts 6a are provided on the outer faces 3c, 3d of the films 3x, 3y. Further microchips 7 or further soldered joints 8, for example, may be fitted to these contacts 6a. Via holes 6b form a direct connection between the two films 3x, 3y. On its path from one film 3x to the opposite film 3y a signal thus passes over the shortest possible distance. In this case, the signal passes through a single via hole 6b between the two films 3x, 3y.

FIG. 4 shows a section at right angles through a further exemplary embodiment of a printed circuit 1 according to the invention., Further layers composed of dielectric 4 and film 3z are applied to the outer faces 3c, 3d of the pressed films 3x, 3y. Contacts 6c, for example via holes, can expediently be formed between the films 3z and the pressed films 3x, 3y.

1-10. (canceled)

11. An arrangement for increasing a packing density on a printed circuit with surface mounted electrical components the printed circuit comprising:
two films pressed against one another with a dielectric arranged between them; and
at least one of mutually opposite faces of the films being fitted with surface mounted electrical components via holes being provided in the printed circuit-to connect the two films,
wherein each via hole of the via holes are a direct connection between the mutually opposite faces of the films.

12. The arrangement as claimed in claim 11, further comprising further surface mounted electrical components arranged on faces of the two films which are not mutually opposite.

13. The arrangement as claimed in claim 11, further comprising a further layer of a dielectric and a further film being applied to at least one face of the printed circuit.

14. The arrangement as claimed in claim 11, wherein the two films contain copper.

15. The arrangement as claimed in claim 11, further comprising first contacts formed on at least one face of the printed circuit.

16. The arrangement as claimed in claim 13, wherein the via holes are formed between the two films and the further film.

17. The arrangement as claimed in claim 11, wherein the surface mounted electrical components are resistors, coils or capacitors.

18. A stack having a plurality of printed circuits as claimed in claim 11 arranged one on top of another.

19. The arrangement as claimed in claim 14, wherein the via holes are formed between the two films and a further film.

20. The arrangement as claimed in claim 15, wherein the via holes are formed between the two films and a further film.

21. The arrangement as claimed in claim 11, wherein the two films are compressed films.

22. A process for fabricating a printed circuit, comprising:
providing two films against one another, the two films having mutually opposite faces;
arranging a dielectric between the two films; and
fitting at least one of the mutually opposite faces of the films with surface mounted electrical components and via holes,
wherein each via hole of the via holes are arranged in direct connection between the mutually opposite faces of the films.

23. The process as claimed in claim 22, further comprising providing a further layer of dielectric and a further film applied to at least one face of the two films.

24. The process as claimed in claim 22, wherein the via holes are microvias.

25. The process as claimed in claim 22, wherein the via holes are produced by one of drilling, electroplating and etching processes.

26. The process as claimed in claim 22, further comprising pressing together the two films.

27. The process as claimed in claim 22, further comprising arranging further surface mounted electrical components on faces of the two films which are not mutually opposite.

28. The process as claimed in claim 22, further comprising embedding the surface mounted electrical components in the dielectric.

29. The process as claimed in claim 22, further comprising soldering the surface mounted electrical components to the two films.

30. The process as claimed in claim 22, further comprising providing first contacts which are formed on at least one face of the two films such that electrical connections are made to another printed circuit.
